(19) United States
(12) Patent Application Publication
(10) Pub. No.: US 2011/0180639 A1
(43) Pub. Date: Jul. 28, 2011

(54) COMPRESSION DEVICE FOR SHREDDING PLANT

(75) Inventors: John Lester, Worksop (GB); Craig Rose, Sheffield (GB)

(73) Assignee: DANIELI DAVY DISTINGTON LTD., Sheffield (GB)

(21) Appl. No.: 13/001,264

(22) PCT Filed: Jun. 24, 2009
(86) PCT No.: PCT/EP09/57865

§ 371 Date: Mar. 15, 2011

(30) Foreign Application Priority Data
Jun. 26, 2008 (IT) UD2008A000147

(51) Int. Cl. B02C 23/02; B02C 21/00

(52) U.S. Cl. 241/34; 241/101.4

(57) ABSTRACT

A compression device for a scrap-shredding plant, comprising at least a rotating roller element able to cooperate with a feed surface for feeding of scrap to the plant in order to grip and compress the scrap between the roller element and the feed surface. The roller element comprises a hollow tubular structure able to be dis-assembled, having semi-cylindrical cap elements reciprocally coupled during use with a rotation shaft of the rollers.

### FIELD OF THE INVENTION

The present invention concerns a compression device able to be used in a plant for shredding, advantageously but not-restrictively, scrap such as for example vehicles, trailers or other, in which the scrap is loaded whole and is shredded so as to reduce the bulk and to sub-divide the different materials of which it is made up, for example metal, glass, plastic or other. In particular, the compression device according to the present invention is disposed at an entrance to the shredding plant, in order to exert a compression and/or crushing of the scrap before it is shredded.

### BACKGROUND OF THE INVENTION

Plants for shredding scrap are known, such as for example vehicles, trailers or other, in which the scrap is loaded substantially whole and is shredded, both to reduce the bulk and also to separate efficiently the materials that make it up.

Known plants comprise a pressing device, associated with means for conveying the scrap, such as for example a slide. The compression device is suitable for gripping and conveying in a controlled manner the scrap entering, which is then processed by a shredder unit disposed downstream of the compression device.

The known pressing device comprises roller elements disposed adjacent, each kept in rotation by a drive shaft around a substantially horizontal axis and transverse with respect to the direction of feed of the scrap. The roller elements have intermittent transversal equally spaced protuberances, radially disposed on a cylindrical surface of each roller element. These protuberances are a suitable to grip and tear the scrap entering the shredding unit.

The roller elements are mounted between two supporting plates, hinged at one end and selectively movable by means of lifting devices such as hydraulic pistons or other. The movement of the supporting plates allows to position the roller elements at a desired distance with respect to a feed surface of the scrap on the conveyor means, according to the size and also the bulk of the scrap. In this way, the scrap introduced into the shredding plant is pressed through reciprocal crushing between the lateral surfaces of each roller element and the feed surface itself. The roller elements are also disposed at decreasing distances from the feed surface so as to exert a progressive crushing action on the scrap advancing towards the shredder unit.

One disadvantage of the known pressing device is that, if a roller element jams, due to dimensions and/or the bulk of the scrap not compatible with, the applied torque may damage the drive shaft.

A further disadvantage of the known pressing device is that, in order to ensure an efficient crushing action, the supporting plates, to which the axis of rotation of the roller elements are attached, must be of considerable size, being the supporting plates structure solid. This generates, during the crushing of the scrap, transversal oscillations of the roller elements, which may be transferred to the supporting plates. These unwanted oscillations accelerate the wear of the compression device and may cause a structural failure of the compression device, i.e. of the roller elements.

A further disadvantage of the known pressing device is that, the transversal protuberances may cause a loss of grip on the entering scrap, making it advance in the shredder unit, crushed in an inefficient way. This may cause an overload of the shredding unit, damages and/or larger power consumption.

Purpose of the present invention is to achieve a compression device for a scrap-shredding plant which is easy and simple to maintain and which allows to reduce both the wear of the roller elements and to decrease its maintenance time and costs.

The Applicant has devised, tested and embodied the present invention to overcome the shortcomings of the state of the art and to obtain these and other purposes and advantages.

### SUMMARY OF THE INVENTION

The present invention is set forth and characterized in the independent claim, while the dependent claims describe other characteristics of the invention or variants to the main inventive idea.

In accordance with the above purpose, a compression device for a scrap-shredding plant according to the present invention is disposed upstream of a shredder unit of the plant. The compression device is associated with movement means suitable to feed the scrap by advancing it towards the shredder unit.

The compression device comprises at least a roller element, rotating around an axis of rotation which is transverse to the direction of feed of the scrap. The roller element is suitable to grip and press, under its weight, the scrap introduced into the plant. The scrap is crushed between the roller element and a feed surface of the scrap, associated with the movement means.

According to a characteristic feature of the present invention, the roller element comprises a hollow tubular structure suitable to be dis-assembled, having elements with a semi-cylindrical cap, coupled during use with a rotation shaft of the roller. In this way it is possible to create interchangeability, of the roller elements helping both assembling and maintenance operations of the plant itself, as the substitution of a worn out semi-cylindrical cap.

According to a variant of the invention, the compression device also comprise, support means on which the roller element is mounted. The support means is selectively mobile so as to dispose the roller element at a desired distance with respect to the feed surface and coherent with the scrap to be treated. The compression device also comprises a first sensing means suitable to sense the grip of the roller element with the entering scrap, allowing the activation of both the support means to make the roller element climb the entering scrap, in a coordinate way with their advance, and the crushing of the scrap itself In this way it is possible to control the advance of the scrap treated by the compression device, so controlling the feeding of the shredding unit, avoiding its possible overloads or absorbed peak power.

According to a variant of the present invention, the compression device is associated to second sensing means suitable to sense, directly or indirectly, the quantity of scrap in the shredding unit. In this way it is possible to feed the shredding unit with a quantity of scrap suitable to make the shredding unit work in efficient conditions, so decreasing the maintenance costs.

According to a variant of the present invention, the support means comprises oblong tubular elements which are pivoted at a first end to a box-like body of the shredding plant. Each oblong tubular element comprises, at a second end, attachment elements, in order to assemble the roller element in its transverse position.

According to a variant of the invention, the compression device also comprises reinforcement elements associated with the oblong tubular elements. The reinforcement elements are suitable to strengthen the hold of the tubular elements, both longitudinally and transversely, in order to support the roller element.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a lateral schematic view of a compression device for a scrap-shredding plant according to the present invention in a first working configuration;

FIG. 2 is a lateral schematic view of the device in FIG. 1 in a second working configuration;

FIG. 3 is a lateral schematic view of the device in FIG. 1;

FIG. 4 is a three-dimensional view of a detail of the device in FIG. 3;

FIG. 5 is an exploded three-dimensional view of the detail in FIG. 3.

### DETAILED DESCRIPTION OF A PREFERENTIAL FORM OF EMBODIMENT

With reference to the attached drawings a compression device 10 according to the present invention is able to be used for pressing and crushing scrap introduced into a scrap shredding plant 14. The compression device 10 is mounted on lateral walls of a box-like body 12 of the plant 14 and is associated with a slide 16 that conveys the scrap towards a compartment 18 in which a scrap shredder unit is disposed, of a known type and not shown in the drawings.

The compression device 10 comprises two cylindrical rollers 20, 120, a lower one 20 and an upper one 120, suitable for gripping the scrap introduced into the plant 14 through the slide 16. The rollers 20, 120 are disposed so as to rotate around an axis of rotation substantially horizontal and transverse to the direction of feed of the scrap on the slide 16. The compression device 10 comprises a drive unit of a known type, like as a hydraulic drive, directly connected to the lower roller directly. The upper roller 120 is connected to the lower roller 20 by a known transmission means so as to keep both roller elements 20, 120 in rotation with a desired differential speed of rotation. In this case the lower roller element 20 is suitable to turns faster than the upper roller element 120 to exert a stretching action on the treated scrap.

The rollers 20, 120 comprise ribs 21, which protrude radially from an external cylindrical surface and extend over the whole width L of each roller element 20, 120 between two circular crowns 19. The ribs 21 are equally spaced on the cylindrical surface. Therefore the ribs 21 are suitable to perform, during the rotation of the roller elements, a gripping action on the scrap introduced into the plant 14.

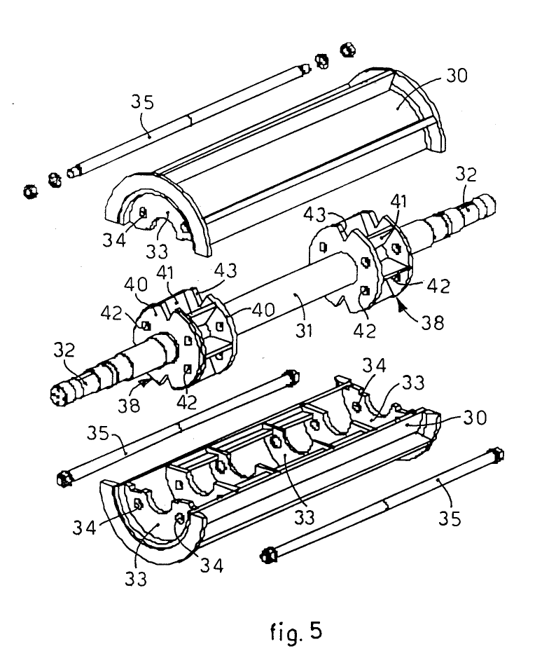

As shown in FIGS. 4 and 5, the rollers 20, 120 can be dis-assembled and comprise two semi-cylindrical caps 30 suitable to be coupled during use with a shaft 31 which defines the axis of rotation of each roller 20, 120.

The ends 32 of the shaft 31 are coupled with the attachment housings of each arm 22. The semi-cylindrical caps 30 comprise semi-circular crowns 33, made in their concave part, so as to define during use, that is, with the caps 30 reciprocally coupled so as to form a roller 20, a seating which the shaft 31 can pass through. Each semi-circular crown 33 also comprises four first through holes 34, suitable for the insertion of an attachment rod 35 disposed during use parallel to the shaft 31.

The shaft 31 also comprises two spacers 38, suitable to be coupled during use with the semi-circular crowns 33 of the caps 30, so as to dispose the shaft 31 centrally and stably between the caps 30. Each spacer 38 comprises a pair of plane circular plates 40, solid and concentric with the shaft 31 and disposed orthogonally with respect to the shaft 31. The plates 40 are also disposed at a predetermined distance from each other. The spacers 38 also comprise second plane plates 41, protruding radially from the shaft 31 and interposed orthogonally between each pair of plates 40 so as to increase the hold of the plates 40 and to increase the resistance to stress of the spacers 38.

Furthermore, each plate 40 comprises second holes 42, having a disposition substantially analogous to that of the first holes 34. The second holes 42 are suitable for the insertion of corresponding rods 35 for the attachment of the shaft 31 to the caps 30. Advantageously, each plate 40 also comprises V-shaped hollows 43 suitable to cooperate with corresponding protuberances, not shown in the drawings, made on an internal surface of the cap 30 to ensure both a better hold of the shaft and the cap 30 during the rotation of the roller 20 and also a correct alignment of the first holes 34 with the second holes 42 for the insertion of the rods 35.

The device 10 also comprises two arms 22, substantially oblong, one for each side of the slide 16, which are suitable for the assembly and support of the rollers 20, 120 in a suspended and transverse position with respect to a feed surface of the slide 16. In fact, the arms 22, pivoted at a first end 23 to the box-like body 12, comprise at a second end 24 housings for the assembly and disposition of the rollers 20, 120 in said suspended position. In particular, the lower roller 20, disposed nearer the shredder unit, is disposed at a distance from said feed surface of the slide 16 that is less than the corresponding distance of the upper roller 120 from said slide 16.

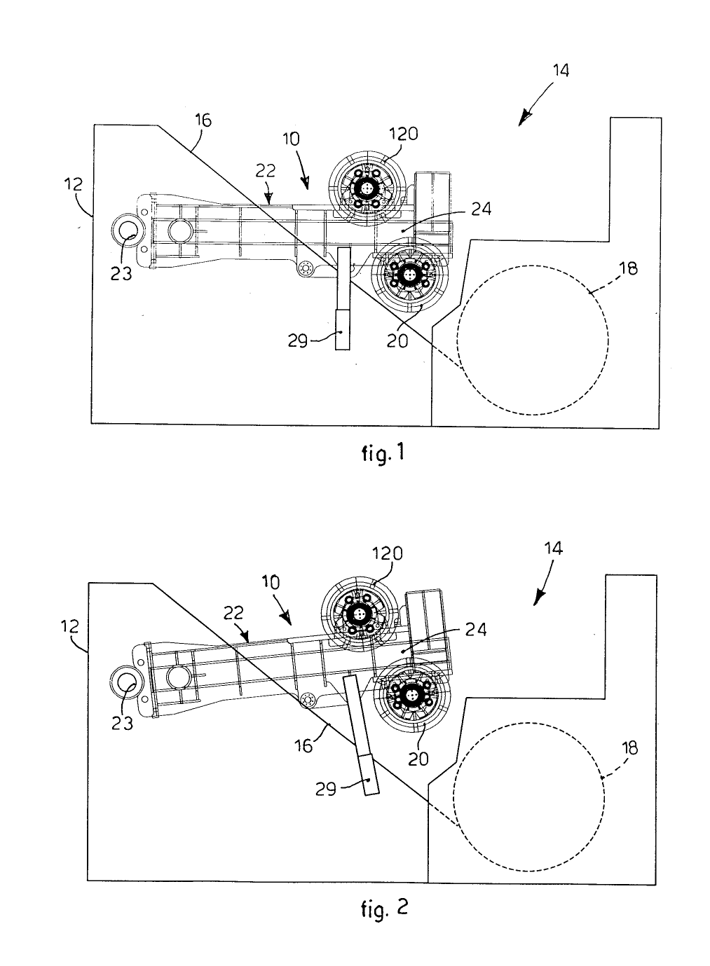

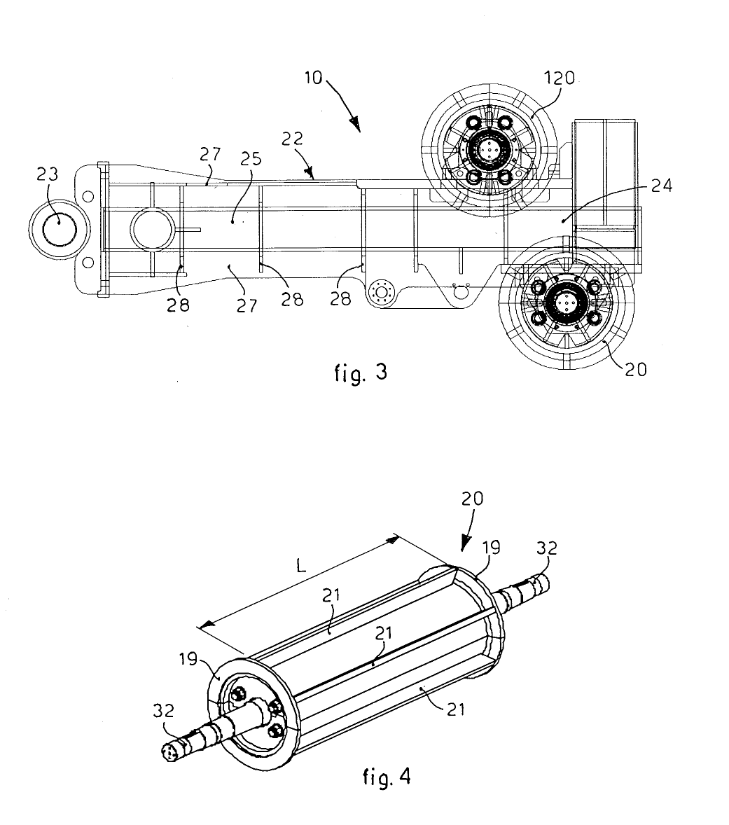

The arms 22 are selectively mobile, oscillating in correspondence with their first end 23, between a first position (FIG. 1), substantially horizontal, and a second inclined position (FIG. 2). In their first position the arms 22 dispose the lower roller 20 almost in contact with the feed surface of the slide 16. In their second position (FIG. 2) the lifting arms dispose the lower roller 20 at a predetermined distance from the feed surface of the slide 16. The upper roller 120 is therefore always disposed at a greater distance from the slide 16 than the first roller 20, both when the arms 22 are disposed in the first position and also when they are disposed in the second position.

The compression device 10 also comprises pistons 29 disposed in connection between a fixed part of the box-like body 12 and a second end 24 of the arm 22 and are suitable to move the arms 22, through oscillation, between said first and second positions.

The arms 22 comprise an oblong tubular body 25, substantially cylindrical, which extends longitudinally between the first end 23 and the second end 24. The tubular body 25 allows to considerably strengthen the arms and give rigidity to the compression device 10.

Each tubular body 25 also comprises plane longitudinal plates 27, made in a single piece or welded to the tubular body 25 and disposed along the entire length of the tubular body 25. The longitudinal plates 27 are suitable to strengthen the structure of the tubular body 25.

Each tubular body 25 also comprises transverse plates 28 disposed externally and in predetermined longitudinal positions of the tubular body 25. The transverse plates 28 are disposed to strengthen the tubular body 25 transversely, so as to confer stability and robustness. The transverse plates 28 can be made in a single piece with the tubular body 25, or welded to it.

The compression device 10 as described heretofore functions as follows.

The scrap to be treated is introduced into the shredding plant 14 and is deposited and made to advance by gravity on the slide 16. The scrap is thus grasped by the ribs 21 of the roller elements 20, 120 which are rotating when the scrap enters in the shredding plant 14. The upper roller 120, grasps the scrap before the lower roller 20. The greater rotation speed of the lower roller 20 than the upper roller 20 causes a stretching of the scrap grasped at the same time by the couple of rollers 20, 120. In this way the density of the scrap, entering the compartment 18 of the shredding unit, is decreased, thus allowing a more efficient shredding action.

The ribs 21 of the rollers 20, 120 allows to indent and maintain the grip on the scrap itself, avoiding unwanted accumulation in the shredding unit. This allows to feed in an efficient way the shredding unit, avoiding overloads and higher power consumption or lowering in the scrap shredding.

In a coordinate way with the advance of the scrap on the slide 16 and the gripping action of the roller 20, 120 on the scrap itself, the arms 22 rotate, swinging between their first and second position, in case assisted by the pistons 29, so as to allow the raising/lowering of the rollers 20,120 over the scrap to be treated, in a coherent way with its dimension and shape. The gripping action of the ribs 21, associated to the rotation of the rollers 20, 120, allow the advance of the scrap on the slide 16 together with its contemporaneous stretching and crushing, substantially by the overall weight of the rollers 20, 120 and the arms 22.

Moreover, the arms 22 and connected rollers 20, 120 are disposed so to allow possible torsional twist only in a useful way to grip the scrap itself. In this way it is possible to substantially decrease the fatigue stresses of the compression device 10 itself.

The gripping action of the rollers 20, 120 on the entering scrap is sensed indirectly as for example by a pressure increase as sensed by corresponding sensor which are associated to the hydraulic motor that moves the rollers. In this way, it is possible to activate, when needed, the lifting devices to help the twisting of the arms 22 and/or the activation of the lifting devices to allow said raising/lowering of the rollers 20, 120 on the scrap.

Moreover, the compression device 10 is associated to a sensor suitable to sense the scrap quantity contained in the compartment 18 of the shredding unit. Such sensor comprise, for instance, a transducer suitable to sense the rotation speed of a drive associated to the shredding unit. Such transducer is connected to a control unit suitable to activate the rollers 20, 120 and the lifting devices. In this way it is possible to feed in a controlled manner the shredding unit, actuating the drive of the rollers 20, 120 on the ground of the information of the quantity of scrap effectively present in the shredding unit. Doing so, it is possible to slow down or, if the case, to stop the rollers 20, 120 and the lifting devices, so slowing down or stopping the flow of entering scrap in the compartment 18, until a suitable condition for reactivate the shredding unit is reached.

In order to dis-assemble the rollers 20, 120, for maintenance and/or for wear purposes, the rollers 20, 120 are first separated from the compression device 10. Then the rods 35 are removed from the corresponding first holes 34 and second holes 42, allowing to separate, for example by lifting a first semi-cylindrical cap 30, the semi-cylindrical caps 30 from the shaft 31.

The rollers 20, 120 are assembled in an identical but inverse manner, by bringing the caps 30 together to cover the shaft 31 and coupling the hollows 43 with the protuberances in the hollow part of each cap 30. Subsequently the rods 35 are inserted longitudinally into the first and second holes 34, 42, clamping the caps 30 definitively to the shaft 31. The rods 35 are retained in position with the caps 30 by means of attachment elements, for example nuts, so as to prevent them from becoming detached and to ensure stability and rigidity to the rollers 20, 120.

The substantially tubular structure of the rollers 20, 120 and that the rollers 20, 120 can be dis-assembled allows to make the maintenance of the plant 14 more efficient and rapid.

It is clear that modifications and/or additions of parts may be made to the compression device 10 as described heretofore, without departing from the field and scope of the present invention.

It is also clear that, although the present invention has been described with reference to some specific examples, a person of skill in the art shall certainly be able to achieve many other equivalent forms of compression device 10, having the characteristics as set forth in the claims and hence all coming within the field of protection defined thereby.

1. A compression device for a scrap-shredding plant, comprising at least a rotating roller element able to cooperate with a feed surface for feeding of scrap to the plant in order to grip and compress said scrap between said roller element and said feed surface, characterized in that said roller element comprises a hollow tubular structure able to be dis-assembled, having semi-cylindrical cap elements reciprocally coupled during use with a rotation shaft of said rollers.

2. The compression device as in claim 1, characterized in that wherein said semi-cylindrical cap elements are reciprocally coupled, during use, by means of spacer elements, with said rotation shaft.

3. The compression device as in claim 1, characterized in that wherein said roller element comprises ribs able to exert a grip on the scrap interposed between the roller element and the feed surface.

4. The compression device as in claims 3, characterized in that wherein said ribs protruding radially from a cylindrical surface of said roller element and extend over whole length (L). of the roller element.

5. The compression device as in claim 1, comprising a couple of roller elements able to rotate at different speed to exert a stretching action on the scrap.

6. The compression device as in claims 5, comprising support means of said roller element, said support means being selectively mobile in order to position the roller elements at a desired distance from said feed surface, and suitable to compression and/or shredding of the scarp to be treated.

7. Device The compression device as in claims 5, comprising first sensing means able to sense the grip of a lower roller element, of said couple of roller elements, with said scrap to be treated, for the positioning of the associated roller elements over the scrap in a coordinate and coherent way with the progressive advance of the scrap on said feed surface.

8. The compression device as in claim 7, wherein said first sensing means are associated to drive means of said roller elements.

9. The compression device as in claim 1, wherein the compression device is associated to second sensing means able to sense, directly or indirectly, the quantity of scrap contained in a shredding unit feeded by the compression device.

10. The compression device as in claim 1, wherein said support means comprises oblong tubular elements, pivoted at a first end to a box-like body of the shredding plant and having, at a second end, attachment elements in order to assemble said roller element in a transverse position with respect to a direction of feed of the scrap on said feed surface.

11. The compression device as in claim 10, comprising reinforcement elements orthogonally associated with said oblong tubular elements and able to strengthen said oblong tubular elements transversely.

12. The compression device as in claim 10, wherein said reinforcement elements comprise plane transverse plates, made outside said oblong tubular element and disposed in predetermined longitudinal positions of said oblong tubular element.

13. The compression device as in claim 10, comprising reinforcement elements orthogonally associated with said oblong tubular elements and able to strengthen said oblong tubular elements longitudinally.

14. The compression device as in claim 12, wherein said reinforcement elements comprise plane longitudinal plates, made in a single piece or welded to each oblong tubular element.

15. The compression device as in claim 1, comprising actuation devices able to move said oblong tubular elements between said first and second positions.

16. A plant for shredding scrap comprising a device for compressing scrap as in claim 1.
